(19) United States
(12) Patent Application Publication
(10) Pub. No.: US 2015/0022293 A1
(43) Pub. Date: Jan. 22, 2015

(54) ELECTROMAGNETIC CONTACTOR

(71) Applicants: FUJI ELECTRIC FA COMPONENTS & SYSTEMS CO., LTD., Tokyo (JP); FUJI ELECTRIC CO., LTD., Kawasaki-shi (JP)

(72) Inventors: Yasuhiro NAKA, Kounosu-shi (JP); Kouetsu TAKAYA, Kounosu-shi (JP); Kenji SUZUKI, Kounosu-shi (JP); Masayoshi SAKATA, Yokohama-shi (JP)

(21) Appl. No.: 14/508,504

(22) Filed: Oct. 7, 2014

Related U.S. Application Data
(63) Continuation of application No. PCT/JP2013/002993, filed on May 9, 2013.

(30) Foreign Application Priority Data
Jun. 8, 2012 (JP) 2012-131237

(51) Int. Cl. H01H 51/28; H01H 50/36; H01H 50/60

(52) U.S. Cl. CPC H01H 51/281; H01H 50/60; H01H 50/36
USPC 335/153

(57) ABSTRACT

The electromagnetic contactor includes a contact device having a pair of fixed contacts disposed to maintain a predetermined distance and a movable contact disposed so as to be attachable to and detachable from the pair of fixed contacts; an electromagnet unit having a movable plunger that moves the movable contact of the contact device; a hermetic chamber enclosing the pair of fixed contacts, the movable contact, and the movable plunger; an external receptacle that covers the hermetic chamber and electromagnet unit; and a sound insulating resin layer injected and hardened between the hermetic chamber and external receptacle. The electromagnetic contactor reduces the height of a contact device, and thus reduces a size of the electromagnetic contactor, while suppressing electromagnetic repulsion force generated between a movable contact and fixed contacts.

### CROSS REFERENCE TO RELATED APPLICATION

The present application is a continuation application of an International Application No. PCT/JP2013/002993 filed May 9, 2013, and claims priority from Japanese Application No. 2012-131237 filed Jun. 8, 2012.

### TECHNICAL FIELD

The present invention relates to an electromagnetic contactor including fixed contacts, a movable contact attachable to and detachable from the fixed contacts, and an electromagnet unit that drives the movable contact.

### BACKGROUND ART

An electromagnetic contactor that carries out switching of a current path includes a movable contact driven by an exciting coil and movable plunger of an electromagnet unit. That is, when the exciting coil is in a non-exciting state, the movable plunger is biased by a return spring, creating a released state wherein the movable contact is separated from a pair of fixed contacts disposed to maintain a predetermined interval. By exciting the exciting coil in the released state, the movable plunger is moved against the return spring, and the movable contact contacts the pair of fixed contacts, creating an engaged state (for example, refer to PTL 1).

### CITATION LIST

### Patent Literature

PTL 1: Japanese Patent No. 3,107,288

### SUMMARY OF INVENTION

### Technical Problem

However, in the heretofore known example described in PTL 1, when switching from an engaged state to a released state, an arc is generated between the fixed contacts and the movable contact. In order to reliably extinguish the arc when switching a current path along which a large current of in the region of, for example, several tens to several hundreds of amps, flows, it is necessary to provide a long distance between the fixed contacts and movable contact in a released state, and the return spring for switching from an engaged state to a released state has a large biasing force. Consequently, it is necessary to increase the electromagnetic force generated in the electromagnet unit that drives the movable plunger, and there is an unresolved problem that a loud contact noise is emitted when the movable plunger moves the contact mechanism to an engaged position or a released position.

Therefore, the invention, focusing on the unresolved problem of the heretofore known example, has an object of providing an electromagnetic contactor to cut out contact noise when a movable plunger is moved to an engaged position or a released position.

### Solution to Problem

In order to achieve the object, one aspect of an electromagnetic contactor according to the invention includes a contact device having a pair of fixed contacts disposed to maintain a predetermined distance and a movable contact disposed so as to be attachable to and detachable from the pair of fixed contacts, and an electromagnet unit having a movable plunger that moves the movable contact of the contact device. Further, the electromagnetic contactor has a hermetic chamber enclosing the pair of fixed contacts, the movable contact, and the movable plunger, an external receptacle that covers the hermetic chamber and the electromagnet unit, and a sound insulating resin layer injected and hardened between the hermetic chamber and the external receptacle.

According to this configuration, a pair of fixed contacts, a movable contact, and a movable plunger are disposed in a hermetic chamber, the hermetic chamber and an electromagnet unit are covered by an external receptacle, and a sound insulating resin layer is formed between the external receptacle and the hermetic chamber, thereby, with the sound insulating resin layer, it is possible to reliably cut out contact noise generated in the hermetic chamber by the movable contact contacting the pair of fixed contacts or, for example, contact noise between the movable plunger and a movable plunger position regulating member when the movable contact moves away from the pair of fixed contacts.

Also, in a second aspect of the electromagnetic contactor according to the invention, the external receptacle includes an external case and an internal case disposed inside the external case, and an encapsulated air layer is formed between side surfaces of the external case and the internal case facing each other.

According to the second aspect, as an encapsulated air layer is formed between the facing side surfaces of the internal case, which forms the outer side of the sound insulating resin layer, and the external case, it is also possible to obtain a sound insulating advantage from the encapsulated air layer, and thus possible to reliably prevent contact noise in an engaged position and a released position from leaking to the exterior.

Also, in a third aspect of the electromagnetic contactor according to the invention, the thicknesses of the sides of the external case and the thicknesses of the sides of the internal case are set to be different.

According to the third aspect, as the thicknesses of the sides of the external case and the thicknesses of the sides of the internal case are different, it is possible to have different resonance frequencies of the external case and internal case, and thus possible to increase the sound insulating advantage of the external receptacle.

Also, in a fourth aspect of the electromagnetic contactor according to the invention, the hermetic chamber includes a tub-form contact housing case inside which the pair of fixed contacts and the movable contact are disposed and which has an opening at an electromagnet unit side thereof, a closing plate that covers an opened end of the contact housing case and through which at least a connecting shaft connecting the movable plunger and movable contact is inserted, and a cap disposed such that the movable plunger moves freely, and hermetically fixed to a side of the closing plate opposite to that of the contact housing case.

According to the fourth aspect, as the drive unit that causes the movable contact to move is disposed in the hermetic chamber, the sound insulating resin material does not encroach inside the hermetic chamber even when the sound insulating resin layer is formed by injecting the sound insulating resin material around the hermetic chamber, and the movement of the movable contact is not affected.

Also, in a fifth aspect of the electromagnetic contactor according to the invention, the closing plate includes an upper magnetic yoke forming the electromagnet unit.

According to the fifth aspect, as the closing plate includes an upper magnetic yoke of the electromagnet unit, no separate closing plate is used, and it is thus possible to reduce the number of parts.

### Advantageous Effects of Invention

According to the invention, as at least a pair of fixed contacts, a movable contact, and a movable plunger are disposed in a hermetic chamber, and the hermetic chamber and an electromagnet unit are covered by a sound insulating resin layer, it is possible to reliably cut out contact noise generated when the movable contact is moved to an engaged position or a released position.

### BRIEF DESCRIPTION OF DRAWINGS

FIG. 1 is an exploded perspective view showing an example of an electromagnetic contactor according to the invention.

FIG. 2 is a sectional view showing an example of the electromagnetic contactor according to the invention.

FIG. 3 is a sectional view along an A-A line of FIG. 2.

FIGS. 4(a), 4(b) and 4(c) are illustrations, each accompanying a description of arc extinguishing by an arc extinguishing permanent magnet according to the invention.

FIGS. 5(a), 5(b) and 5(c) are illustrations, each accompanying a description of arc extinguishing when the arc extinguishing permanent magnet is disposed on the outer side of an insulating case.

FIGS. 6(a) and 6(b) are diagrams, each showing another example of a contact housing case that may be applied to the invention, wherein FIG. 6(a) is an exploded perspective view and FIG. 6(b) is a sectional view.

FIGS. 7(a) and 7(b) are diagrams, each showing a modification example of a contact device of the invention, wherein FIG. 7(a) is a sectional view and FIG. 7(b) is a perspective view.

FIGS. 8(a) and 8(b) are diagrams, each showing another modification example of the contact device of the invention, wherein FIG. 8(a) is a sectional view and FIG. 8(b) is a perspective view.

### DESCRIPTION OF EMBODIMENTS

Hereafter, a description will be given, based on the drawings, of embodiments of the invention.

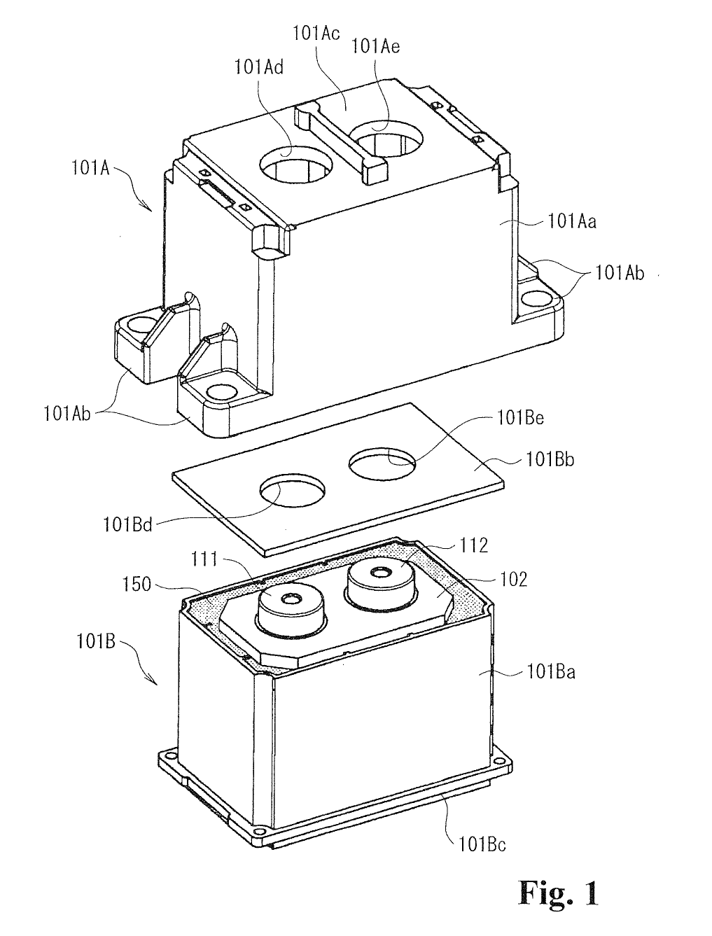

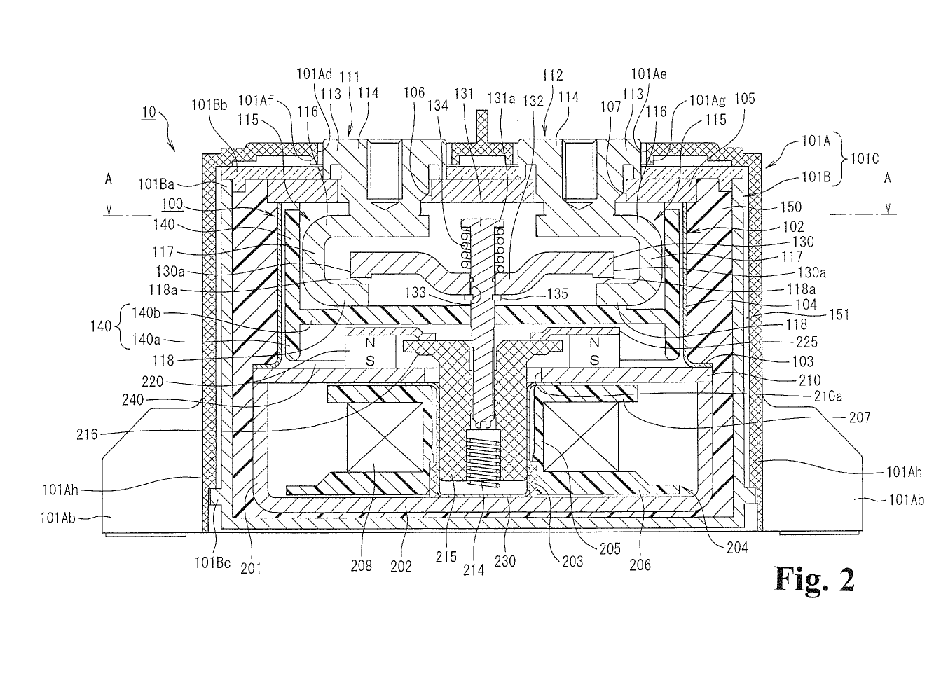

FIG. 1 is an exploded perspective view showing a first embodiment of an electromagnetic switch according to the invention, while FIG. 2 is a sectional view. In FIG. 1 and FIG. 2, 10 is an electromagnetic contactor, and the electromagnetic contactor 10 includes a contact device 100 in which a contact mechanism is disposed, and an electromagnet unit 200 that drives the contact device 100.

The electromagnetic contactor 10, as clearly shown in FIG. 1 and FIG. 2, includes an external receptacle 101C having an external case 101A, made of a synthetic resin, and an internal case 101B, made of a synthetic resin, disposed inside the external case 101A. Also, the electromagnetic contactor 10 has a contact housing case 102 that houses a contact mechanism disposed inside the internal case 101B.

The external case 101A includes a bottomed cylinder 101Aa having an opening at the lower end thereof, and attachment flange portions 101Ab disposed on side surfaces on the opened end surface side of the bottomed cylinder 101Aa. Aperture portions 101Ad and 101Ae in which the upper ends of a pair of fixed contacts 111 and 112 are exposed are formed in a top plate portion 101Ac of the bottomed cylinder 101Aa. Also, cylindrical portions 101Af and 101Ag that engage the upper surface of a cover plate 101Bb of the internal case 101B are formed on the lower surface side of the aperture portions 101Ad and 101Ae on the top plate portion 101Ac.

The internal case 101B includes a bottomed cylinder 101Ba having an opening at the upper end thereof, and the cover plate 101Bb closing off the upper end of the bottomed cylinder 101Ba. A peripheral flange 101Bc that engages a stepped portion 101Ah formed on the inner peripheral surface of the bottomed cylinder 101Aa of the external case 101A is formed on the lower surface side of the outer surface of the bottomed cylinder 101Ba. Also, insertion holes 101Bd and 101Be through which flange portions 113 of the fixed contacts 111 and 112 are inserted, to be described hereafter, are formed in the cover plate 101Bb.

The contact device 100 has the contact housing case 102, as shown in FIG. 2. The contact housing case 102 includes a metal tubular body 104 having a flange portion 103 arranged on a metal lower end portion and protruding outward, and a fixed contact support insulating substrate 105 forming a top plate formed of a plate-like ceramic insulating substrate that closes off the upper end of the metal tubular body 104, as shown in FIG. 2.

The metal tubular body 104 is formed such that the flange portion 103 thereof is seal-joined and fixed, in a hermetic state, to an upper magnetic yoke 210 of the electromagnet unit 200, to be described hereafter.

Also, through holes 106 and 107 in which the pair of fixed contacts 111 and 112 is inserted, to be described hereafter, are formed to maintain a predetermined interval in a central portion of the fixed contact support insulating substrate 105. A metalizing process is performed around the through holes 106 and 107 on the upper surface side of the fixed contact support insulating substrate 105, and in a position on the lower surface side that contacts the metal tubular body 104. In order to carry out the metalizing process, copper foil is formed around the through holes 106 and 107, and in the position that contacts the metal tubular body 104, in a condition wherein a plurality of the fixed contact support insulating substrate 105 is arranged vertically and horizontally on a flat surface.

Also, the contact device 100, as shown in FIG. 2, includes the pair of fixed contacts 111 and 112 inserted into and fixed in the through holes 106 and 107 of the fixed contact support insulating substrate 105 of the contact housing case 102. Each of the fixed contacts 111 and 112 includes a support conductor portion 114, having the flange portion 113 arranged on an upper end and protruding outward, inserted into the through holes 106 and 107 of the fixed contact support insulating substrate 105, and a contact conductor portion 115, the inner side of which is opened, linked to the support conductor portion 114 and disposed on the lower surface side of the fixed contact support insulating substrate 105.

The contact conductor portion 115 includes an upper plate portion 116 extending to the outer side along the line of the lower surface of the fixed contact support insulating substrate 105, a connecting plate portion 117 extending downward from the outer side end portion of the upper plate portion 116, and a lower plate portion 118 as a contact plate portion extending from the lower end side of the connecting plate portion 117, parallel with the upper plate portion 116, to the inner side, that is, in a direction facing the fixed contacts 111 and 112. Because of this, the contact conductor portion 115 is formed in a C-shape wherein the upper plate portion 116 is added to an L-shaped portion formed by the connecting plate portion 117 and lower plate portion 118.

Herein, the support conductor portion 114 and contact conductor portion 115 are fixed by, for example, brazing in a condition in which, although not shown, a pin protruding on the lower end surface of the support conductor portion 114 is inserted into a through hole formed in the upper plate portion 116 of the contact conductor portion 115. The fixing of the support conductor portion 114 and contact conductor portion 115, not being limited to brazing, may be such that the pin is fitted into the through hole, or an external thread is formed on the pin and an internal thread formed in the through hole, and the two are screwed together.

Furthermore, although not shown, an insulating cover, made of a synthetic resin material, that regulates arc generation is mounted in the contact housing portion 115 of each of the fixed contacts 111 and 112, by exposing only the lower plate portion 118, and covering at least the front and back side surfaces and inner side surface of the connecting plate portion 117 and the lower surface and front and back side surfaces of the upper plate portion 116.

Further, the movable contact 130 is disposed in such a way that both end portions are disposed inside the contact conductor portion 115 of the fixed contacts 111 and 112. The movable contact 130 is supported by a connecting shaft 131 fixed to a movable plunger 215 of the electromagnet unit 200, to be described hereafter. The movable contact 130 is formed such that, as shown in FIG. 2, a central portion in the vicinity of the connecting shaft 131 protrudes downward, whereby a depressed portion 132 is formed, and a through hole 133 in which the connecting shaft 131 is inserted is formed in the depressed portion 132.

A flange portion 131a protruding outward is formed on the upper end of the connecting shaft 131. The connecting shaft 131 is inserted from the lower end side into a contact spring 134, then inserted into the through hole 133 of the movable contact 130, and contacting the upper end of the contact spring 134 with the flange portion 131a, and the movable contact 130 is positioned by, for example, a C-ring 135 so as to obtain a predetermined biasing force from the contact spring 134.

The movable contact 130, in a released state, is in a condition wherein contact portions 130a and contact portions 118a of the lower plate portions 118 of the contact conductor portions 115 of the fixed contacts 111 and 112 are separated from each other to maintain a predetermined interval. Also, the movable contact 130 is set such that, in an engaged position, both ends of the contact portions contact the contact portions 118a of the lower plate portions 118 of the contact conductor portions 115 of the fixed contacts 111 and 112 at a predetermined contact pressure from the contact spring 134.

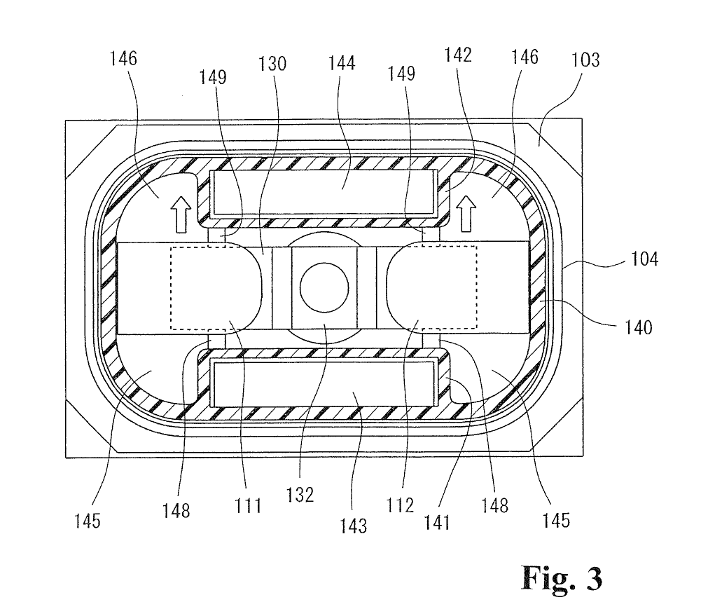

Furthermore, an insulating cylinder 140 formed in a bottomed tubular form of a bottom plate portion 140a and a tubular body 140b formed on the upper surface of the bottom plate portion 140a, is disposed on the inner peripheral surface of the metal tubular body 104 of the contact housing case 102, as shown in FIG. 2. The insulating cylinder 140 is made of, for example, a synthetic resin, and the bottom plate portion 140a and tubular body 140b are formed integrally. Magnet housing cylinders 141 and 142 are formed integrally as magnet housing portions in positions on the insulating cylinder 140 facing the side surfaces of the movable contact 130, as shown in FIG. 3. Arc extinguishing permanent magnets 143 and 144 are inserted into and fixed in the magnet housing cylinders 141 and 142.

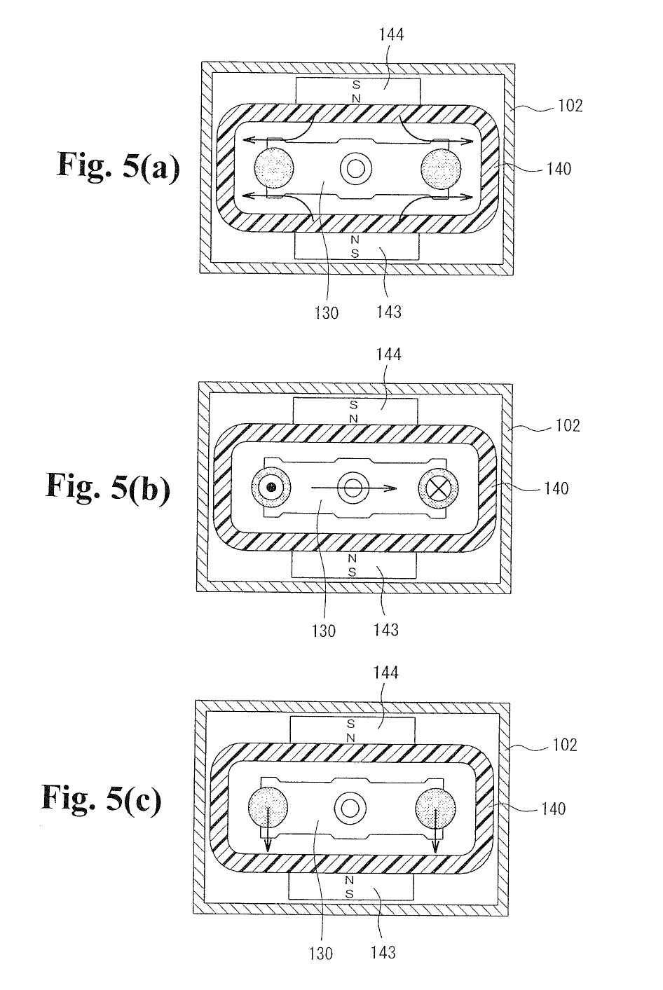

The arc extinguishing permanent magnets 143 and 144 are magnetized in a thickness direction such that mutually opposing magnetic pole faces thereof are homopolar, such as N-poles. Also, the arc extinguishing permanent magnets 143 and 144 are set such that both end portions in a left-right direction are slightly inward of positions in which the contact portions 118a of the fixed contacts 111 and 112 and the contact portions of the movable contact 130 are opposed, as shown in FIG. 5. Further, arc extinguishing spaces 145 and 146 are formed on the outer sides in a left-right direction, that is, the longitudinal direction of the movable contact, of the magnet housing cylinders 141 and 142 respectively.

Also, movable contact guide members 148 and 149, which regulate the turning of the movable contact 130, by sliding against side edges of the magnet housing cylinders 141 and 142 close to both ends of the movable contact 130, are formed.

Consequently, the insulating cylinder 140 includes a function of positioning the arc extinguishing permanent magnets 143 and 144 by the magnet housing cylinders 141 and 42, a protective function of protecting the arc extinguishing permanent magnets 143 and 144 from an arc, and an insulating function preventing the arc from affecting the metal tubular body 104, which increases external rigidity.

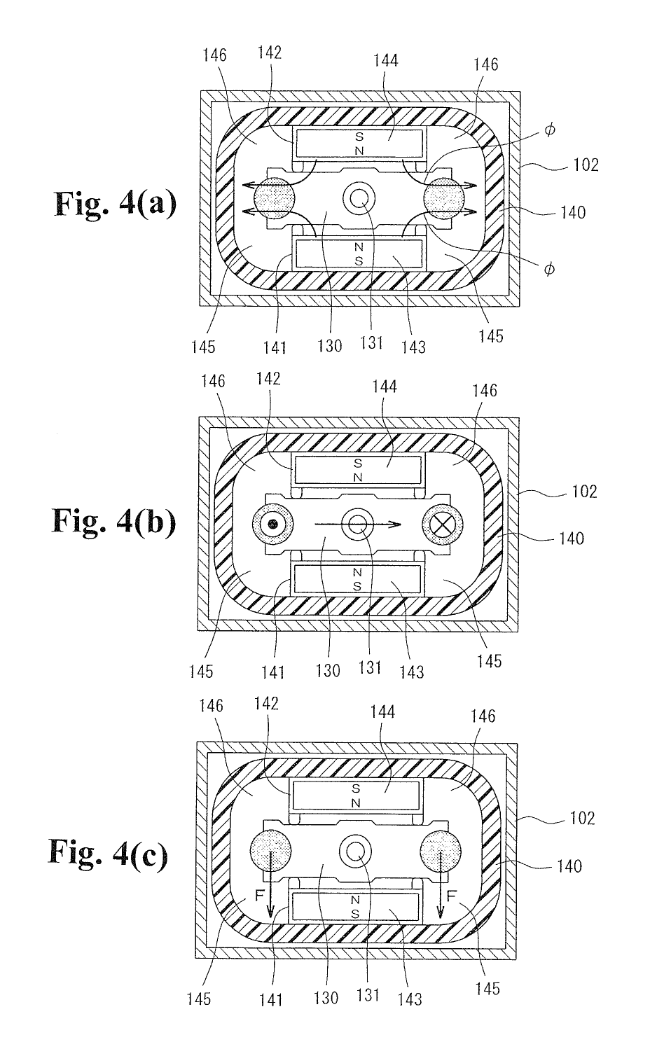

Further, by disposing the arc extinguishing permanent magnets 143 and 144 on the inner peripheral surface side of the insulating cylinder 140, it is possible to bring the arc extinguishing permanent magnets 143 and 144 close to the movable contact 130. Because of this, as shown in FIG. 4(a), magnetic flux φ emanating from the N-pole sides of the two arc extinguishing permanent magnets 143 and 144 crosses portions in which the contact portions 118a of the fixed contacts 111 and 112 and the contact portions 130a of the movable contact 130 are opposed in a left-right direction, from the inner side to the outer side, with a large magnetic flux density.

Consequently, assuming that the fixed contact 111 is connected to a current supply source and the fixed contact 112 is connected to a load side, the current direction in the engaged state is set such that the current flows from the fixed contact 111 through the movable contact 130 to the fixed contact 112, as shown in FIG. 4 (b). Then, when changing from the engaged state to the released state by causing the movable contact 130 to move away upward from the fixed contacts 111 and 112, an arc is generated between the contact portions 118a of the fixed contacts 111 and 112 and the contact portions 130a of the movable contact 130.

The arc is extended to the arc extinguishing space 145 side on the arc extinguishing permanent magnet 143 side by the magnetic flux φ from the arc extinguishing permanent magnets 143 and 144. At this time, as the arc extinguishing spaces 145 and 146 are formed as widely as the thickness of the arc extinguishing permanent magnets 143 and 144, it is possible to obtain a long arc length, and thus possible to reliably extinguish the arc.

Incidentally, when the arc extinguishing permanent magnets 143 and 144 are disposed on the outer side of the insulating cylinder 140, as shown in FIGS. 5(a) to (c), there is an increase in the distance to the positions in which the contact portions 118a of the fixed contacts 111 and 112 and the contact portions 130a of the movable contact 130 are opposed, thereby, when the same permanent magnets as in this embodiment are applied, the density of the magnetic flux crossing the arc decreases.

Because of this, the Lorentz force acting on an arc generated when shifting from the engaged state to the released state decreases, and it is no longer possible to sufficiently extend the arc. In order to improve the arc extinguishing performance, it is necessary to increase the magnetic force of the arc extinguishing permanent magnets 143 and 144. Moreover, in order to shorten the distance between the arc extinguishing permanent magnets 143 and 144 and the contact portions of the fixed contacts 111 and 112 and movable contact 130, it is necessary to reduce the depth in a front-back direction of the insulating cylinder 140, and there is a problem that it is not possible to secure sufficient arc extinguishing space to extinguish the arc.

However, according to the heretofore described embodiment, the arc extinguishing permanent magnets 143 and 144 are disposed on the inner side of the insulating cylinder 140, thereby problems occurring when the arc extinguishing permanent magnets 143 and 144 are disposed on the outer side of the insulating cylinder 140 can be resolved.

The electromagnet unit 200, as shown in FIG. 2, has a magnetic yoke 201 of a flattened U-shape relative to the side direction, and a cylindrical auxiliary yoke 203 is fixed in a central portion of a bottom plate portion 202 of the magnetic yoke 201. A spool 204 is disposed on the outer side of the cylindrical auxiliary yoke 203.

The spool 204 includes a central cylinder portion 205 in which the cylindrical auxiliary yoke 203 is inserted, a lower flange portion 206 protruding outward in a radial direction from a lower end portion of the central cylinder portion 205, and an upper flange portion 207 protruding outward in a radial direction from slightly below the upper end of the central cylinder portion 205. Further, an exciting coil 208 is mounted and wound in a housing space formed by the central cylinder portion 205, lower flange portion 206, and upper flange portion 207.

Further, an upper magnetic yoke 210 is fixed between upper ends forming an opened end of the magnetic yoke 201. A through hole 210a opposing the central cylinder portion 205 of the spool 204 is formed in a central portion of the upper magnetic yoke 210.

Further, the movable plunger 215, in which a return spring 214 is disposed between a bottom portion and the bottom plate portion 202 of the magnetic yoke 201, is disposed in the central cylinder portion 205 of the spool 204 so as to be capable to slide up and down. A peripheral flange portion 216 protruding outward in a radial direction is formed on the movable plunger 215, on an upper end portion protruding upward from the upper magnetic yoke 210.

Also, a permanent magnet 220 formed in a ring-form, having an external form such as rectangular and the circular through hole 210a, is fixed to the upper surface of the upper magnetic yoke 210 so as to enclose the peripheral flange portion 216 of the movable plunger 215. The permanent magnet 220 is magnetized in an up-down direction, that is, a thickness direction, such that the upper end side is, for example, an N-pole while the lower end side is an S-pole.

Further, an auxiliary yoke 225 having the same external form as the permanent magnet 220, and a through hole 224 with an inner diameter smaller than the outer diameter of the peripheral flange portion 216 of the movable plunger 215, is fixed to the upper end surface of the permanent magnet 220. The peripheral flange portion 216 of the movable plunger 215 contacts the lower surface of the auxiliary yoke 225.

The form of the permanent magnet 220 is not limited to that heretofore described, and it can also be formed in a circular ring form, and in fact, the external form can be any form, such as circular or polygonal, if the inner peripheral surface has a form tailored to the form of the peripheral flange portion 216.

Also, the connecting shaft 131 that supports the movable contact 130 is screwed to the upper end surface of the movable plunger 215.

Further, the movable plunger 215 is covered with a cap 230 formed in a bottomed tubular form made of a non-magnetic body, and a flange portion 231 extending outward in a radial direction on an opened end of the cap 230 is seal-joined to the lower surface of the upper magnetic yoke 210. Thereby, a hermetic chamber 240, wherein the contact housing case 102 and the cap 230 are communicated via the through hole 210a of the upper magnetic yoke 210, is formed. Further, a gas such as hydrogen gas, nitrogen gas, a mixed gas of hydrogen and nitrogen, air, or SF₆ is encapsulated inside the hermetic chamber 240 formed by the contact housing case 102 and the cap 230.

Further, by injecting a sound insulating resin material such as urethane rubber or silicon rubber into the internal case 101B and hardening in a condition wherein the cover plate 101Bb is removed, as shown in FIG. 1, a sound insulating resin layer 150 is formed, as shown in FIG. 1 and FIG. 2. At this time, as a magnetic yoke includes the U-shaped magnetic yoke 201 and upper magnetic yoke 210 in the electromagnet unit 200, and the front and back end portions of the magnetic yoke are opened, the sound insulating resin material is also injected into the interior of the magnetic yoke 201 and upper magnetic yoke 210, and the spool 204 is sealed with the sound insulating resin material.

Further, the opened end of the bottomed cylinder 101Ba is closed off with the cover plate 101Bb before the sound insulating resin material hardens. The sound insulating resin layer 150 is thicker in a position covering the contact device 100, and thinner in a position covering the electromagnet unit 200, as shown in FIG. 2.

Also, the external case 101A is attached with an adhesive to the outer side of the internal case 101B so as to create a sealed state wherein the stepped portion 101Ah is caused to engage with the peripheral flange 101Bc formed on the internal case 101B, and the cylindrical portions 101Af and 101Ag of the top plate portion 101Ac are caused to engage with the cover plate 101Bb, as shown in FIG. 2. Because of this, an encapsulated air layer 151, wherein air is encapsulated between the inner surface of the external case 101A and outer surface of the internal case 101B, is formed.

Furthermore, the thicknesses of the sides of the external case 101A and the thicknesses of the sides of the internal case 101B are set to be different thicknesses. Herein, the thicknesses of the sides of the external case 101A are set to be greater than the thicknesses of the sides of the internal case 101B. Because of this, the rigidity and resonance frequency of the external cases 101A and the internal case 101B are set to be different.

Next, a description will be given of an operation of the heretofore described embodiment.

Herein, it is assumed that the fixed contact 111 is connected to, for example, a power supply source that supplies a large current, while the fixed contact 112 is connected to a load.

In this condition, the exciting coil 208 in the electromagnet unit 200 is in a non-exciting state, and is in a released state wherein no exciting force causing the movable plunger 215 to descend is generated in the electromagnet unit 200. In this released state, the movable plunger 215 is biased in an upward direction away from the upper magnetic yoke 210 by the return spring 214. Simultaneously with this, a suctioning force caused by a magnetic force of the permanent magnet 220 acts on the auxiliary yoke 225, and the peripheral flange portion 216 of the movable plunger 215 is suctioned. Because of this, the upper surface of the peripheral flange portion 216 of the movable plunger 215 contacts the lower surface of the auxiliary yoke 225.

Because of this, the contact portions 130a of the movable contact 130 of the contact device 100 connected to the movable plunger 215 via the connecting shaft 131 are separated by a predetermined distance upward from the contact portions 118a of the fixed contacts 111 and 112. Because of this, the current path between the fixed contacts 111 and 112 is in an interrupted state, and the contact mechanism is in a state wherein the contacts are opened.

In this way, as the biasing force of the return spring 214 and the suctioning force of the ring-form permanent magnet 220 both act on the movable plunger 215 in the released state, there is no unplanned downward movement of the movable plunger 215 due to external vibration, shock, or the like, and it is thus possible to reliably prevent malfunction.

In the released state, the exciting coil 208 of the electromagnet unit 200 is excited, an exciting force is generated in the electromagnet unit 200, and the movable plunger 215 is caused to descend against the biasing force of the return spring 214 and the suctioning force of the ring-form permanent magnet 220. The descent of the movable plunger 215 is stopped by the lower surface of the peripheral flange portion 216 contacting the upper surface of the upper magnetic yoke 210.

As the movable plunger 215 descends in this way, the movable contact 130 connected to the movable plunger 215 via the connecting shaft 131 also descends, and the contact portions 130a of the movable contact 130 contacts the contact portions 118a of the fixed contacts 111 and 112 with the contact pressure of the contact spring 134.

Because of this, it comes to a closed contact state wherein the large current of the external power supply source is supplied to the load via the fixed contact 111, the movable contact 130, and the fixed contact 112.

At this time, an electromagnetic repulsion force is generated between the fixed contacts 111 and 112 and the movable contact 130 in a direction opening the contacts of the movable contact 130.

However, each of the fixed contacts 111 and 112 includes the contact conductor portion 115 having the upper plate portion 116, the connecting plate portion 117, and the lower plate portion 118, as shown in FIG. 2, thereby the current in the upper plate portion 116 and the lower plate portion 118 and the current in the opposing movable contact 130 flow in opposite directions. Because of this, from the relationship between a magnetic field formed by the lower plate portions 118 of the fixed contacts 111 and 112 and the current flowing through the movable contact 130, it is possible, in accordance with Fleming's left-hand rule, to generate a Lorentz force that presses the movable contact 130 against the contact portions 118a of the fixed contacts 111 and 112.

Because of this Lorentz force, it is possible to oppose the electromagnetic repulsion force generated in the contact opening direction between the contact portions 118a of the fixed contacts 111 and 112 and the contact portions 130a of the movable contact 130, and thus possible to reliably prevent the contact portions 130a of the movable contact 130 from opening. Because of this, it is possible to reduce the pressing force of the contact spring 134 supporting the movable contact 130, and possible to reduce the size of the contact spring 134, and thus possible to reduce the size of the contact device 100.

When interrupting the supply of current to the load in the closed contact state of the contact mechanism, the exciting of the exciting coil 208 of the electromagnet unit 200 is stopped.

Thereby, the exciting force causing the movable plunger 215 to move downward in the electromagnet unit 200 stops, the movable plunger 215 is raised by the biasing force of the return spring 214, and the suctioning force of the ring-form permanent magnet 220 increases as the peripheral flange portion 216 nears the auxiliary yoke 225.

As the movable plunger 215 rises, the movable contact 130 connected via the connecting shaft 131 rises. As a result, the movable contact 130 contacts the fixed contacts 111 and 112 while contact pressure is applied by the contact spring 134. Subsequently, it comes to an opened contact state, wherein the movable contact 130 moves upward from the fixed contacts 111 and 112 when the contact pressure of the contact spring 134 stops.

When the opened contact state starts, an arc is generated between the contact portions 118a of the fixed contacts 111 and 112 and the contact portions 130a of the movable contact 130, and the state in which current is conducted is continued due to the arc. At this time, the insulating cover (not shown) covering the upper plate portion 116 and connecting plate portion 117 of the contact conductor portion 115 of each of the fixed contacts 111 and 112, is mounted. Because of this, it is possible to cause the arc to be generated only between the contact portions 118a of the fixed contacts 111 and 112 and the contact portions 130a of the movable contact 130. Consequently, it is possible to reliably prevent the arc from moving above the contact conductor portion 115 of the fixed contacts 111 and 112, thereby stabilizing the arc generation state, and thus possible to improve arc extinguishing performance. Moreover, as both side surfaces of the fixed contacts 111 and 112 are also covered by the insulating cover, it is also possible to reliably prevent the leading edge of the arc from short-circuiting. Furthermore, the surfaces of the fixed contacts 111 and 112 opposing the upper plate portion 116 of the contact conductor portion 115 and the movable contact 130 of connecting plate portion 117 are covered by the insulating cover, thereby it is possible to bring the upper plate portion 116 and connecting plate portion 117 and the movable contact 130 close together while maintaining the necessary insulating distance, and thus possible to reduce the height of the contact mechanism, that is, the height in the direction in which the movable contact 130 can move.

At this time, the opposing magnetic pole faces of the arc extinguishing permanent magnets 143 and 144 are N-poles, and the outer sides thereof are S-poles. Consequently, magnetic flux emanating from the N-poles, in plan view as shown in FIG. 4(a), crosses an arc generation portion of a portion in which the contact portion 118a of the fixed contact 111 and the contact portion 130a of the movable contact 130 are opposed, from the inner side to the outer side in the longitudinal direction of the movable contact 130, and reaches the S-pole, whereby a magnetic field is formed. In the same way, the magnetic flux crosses an arc generation portion of the contact portion 118a of the fixed contact 112 and the contact portion 130a of the movable contact 130, from the inner side to the outer side in the longitudinal direction of the movable contact 130, and reaches the S-pole, whereby a magnetic field is formed.

Consequently, the magnetic fluxes of the arc extinguishing permanent magnets 143 and 144 cross between the contact portion 118a of the fixed contact 111 and the contact portion 130a of the movable contact 130 and between the contact portion 118a of the fixed contact 112 and the contact portion 130a of the movable contact 130, in mutually opposite directions in the longitudinal direction of the movable contact 130.

Because of this, a current I flows from the fixed contact 111 side to the movable contact 130 side between the contact portion 118a of the fixed contact 111 and the contact portion 130a of the movable contact 130, and the orientation of the magnetic flux φ is in a direction from the inner side toward the outer side, as shown in FIG. 4 (b). Because of this, in accordance with Fleming's left-hand rule, a large Lorentz force F acts toward the arc extinguishing space 145 side, perpendicular to the longitudinal direction of the movable contact 130 and perpendicular to the switching direction of the contact portion 118a of the fixed contact 111 and the movable contact 130, as shown in FIG. 4 (c).

Due to the Lorentz force F, an arc generated between the contact portion 118a of the fixed contact 111 and the contact portion 130a of the movable contact 130 is greatly extended so as to pass from the side surface of the contact portion 118a of the fixed contact 111 through the inside of the arc extinguishing space 145 and to reach the upper surface side of the movable contact 130, and is extinguished.

Also, at the lower side and upper side of the arc extinguishing space 145, magnetic flux inclines to the lower side and upper side with respect to the orientation of the magnetic flux between the contact portion 118a of the fixed contact 111 and the contact portion 130a of the movable contact 130. Because of this, the arc extended to the arc extinguishing space 145 is further extended by the inclined magnetic flux in the direction of the corner of the arc extinguishing space 145, it is possible to increase the arc length, and thus possible to obtain good interruption performance.

Meanwhile, the current I flows from the movable contact 130 side to the fixed contact 112 side between the contact portion 118a of the fixed contact 112 and the movable contact 130, and the orientation of the magnetic flux φ is in a rightward direction from the inner side toward the outer side, as shown in FIG. 4 (b). Because of this, in accordance with Fleming's left-hand rule, a large Lorentz force F acts toward the arc extinguishing space 145, perpendicular to the longitudinal direction of the movable contact 130 and perpendicular to the switching direction of the contact portion 118a of the fixed contact 112 and the movable contact 130, as shown in FIG. 4(c).

Due to the Lorentz force F, an arc generated between the contact portion 118a of the fixed contact 112 and the movable contact 130 is greatly extended so as to pass from the upper surface side of the movable contact 130 through the inside of the arc extinguishing space 145 and to reach the side surface side of the fixed contact 112, and is extinguished.

Also, at the lower side and upper side of the arc extinguishing space 145, as heretofore described, magnetic flux inclines to the lower side and upper side with respect to the orientation of the magnetic flux between the contact portion 118a of the fixed contact 112 and the contact portion 130a of the movable contact 130. Because of this, the arc extended to the arc extinguishing space 145 is further extended by the inclined magnetic flux in the direction of the corner of the arc extinguishing space 145, it is possible to increase the arc length, and thus possible to obtain good interruption performance.

Meanwhile, when it comes to be in a released state from a state wherein a regenerative current flows from the load side to the direct current power source side in the engaged state of the electromagnetic contactor 10, as the direction of current in FIG. 4(b) is reversed, excepting that the Lorentz force F acts on the arc extinguishing space 146 side, and the arc is extended to the arc extinguishing space 146 side, the same arc extinguishing function is fulfilled.

At this time, as the arc extinguishing permanent magnets 143 and 144 are disposed in the magnet housing cylinders 141 and 142 formed in the insulating cylinder 140, the arc does not contact the arc extinguishing permanent magnets 143 and 144. Because of this, it is possible to stably maintain the magnetic characteristics of the arc extinguishing permanent magnets 143 and 144, and thus possible to stabilize interruption performance.

Also, as it is possible to cover and insulate the inner peripheral surface of the metal tubular body 104 with the insulating cylinder 140, there is no short-circuiting of the arc when the current is interrupted, and it is thus possible to reliably carry out current interruption.

Furthermore, as it is possible to carry out the insulating function, the function of positioning the arc extinguishing permanent magnets 143 and 144, the function of protecting the arc extinguishing permanent magnets 143 and 144 from the arc, and the insulating function preventing the arc from reaching the external metal tubular body 104 with the one insulating cylinder 140, it is possible to reduce manufacturing cost.

Also, as the movable contact guide members 148 and 149 that slide against a side edge of the movable contact are formed on the magnet housing cylinders 141 and 142 housing the arc extinguishing permanent magnets 143 and 144 in positions opposing the movable contact 130, it is possible to reliably prevent turning of the movable contact 130.

Also, as it is possible to increase the distance between the side edges of the movable contact 130 and the inner peripheral surface of the insulating case 140 by the thickness of the arc extinguishing permanent magnets 143 and 144, it is possible to provide sufficient arc extinguishing spaces 145 and 146, and thus possible to reliably carry out arc extinguishing.

Furthermore, as the movable contact guide members 148 and 149 that slide against a side edge of the movable contact are formed on the magnet housing cylinders 141 and 142 housing the arc extinguishing permanent magnets 143 and 144 in positions opposing the movable contact 130, it is possible to reliably prevent turning of the movable contact 130.

Further, when the exciting coil 208 is energized in the released state shown in FIG. 2, wherein the movable contact 130 of the contact device 100 has moved upward from the fixed contacts 111 and 112, thereby creating an engaged state wherein the movable plunger 215 is caused to descend against the return spring 214, and the movable contact 130 contacts the contact portions 118a of the fixed contacts 111 and 112 with the contact pressure of the contact spring 134, a contact noise is emitted. The contact noise is emitted when the contact portions 130a of the movable contact 130 contact the contact portions 118a of the fixed contacts 111 and 112.

Conversely, when the energizing of the exciting coil 208 is stopped in the engaged state, the movable plunger 215 is returned upward by the return spring 214, creating a released state wherein the upper surface of the peripheral flange portion 216 of the movable plunger 215 contacts the auxiliary yoke 225. At this time, a contact noise is emitted by the peripheral flange portion 216 of the movable plunger 215 contacting the auxiliary yoke 225.

In the embodiment, however, as previously described, the pair of fixed contacts 111 and 112, the movable contact 130, and the movable plunger 215 are housed in the hermetic chamber 240, the hermetic chamber 240 and the electromagnet unit 200 are covered by the internal case 101B, and a sound insulating resin material is injected into the interior of the internal case 101B, thus forming the sound insulating resin layer 150. Consequently, it is possible to reliably cut out contact noise with the sound insulating resin layer 150 when switching to an engaged state or a released state. Moreover, as the encapsulated air layer 151 is formed between the internal case 101B, which forms the outer side of the sound insulating resin layer 150, and the external case 101A, it is also possible to obtain a sound insulating advantage from the encapsulated air layer 151, and thus possible to more reliably carry out sound insulation.

Furthermore, the thicknesses of the sides of the external case 101A and the thicknesses of the sides of the internal case 101B are set to be different thicknesses. Because of this, the external case 101A and internal case 101B have different rigidities and have different resonance frequencies, thereby it is possible to further suppress propagation to the exterior of contact noise emitted when switching to an engaged state or a released state, and thus possible to further increase the sound insulating advantage.

Also, as the spool 204 is enclosed in the sound insulating resin material by injecting the sound insulating resin material between the magnetic yoke 201 and upper magnetic yoke 210 of the electromagnet unit 200, there is no space portion, that is, no resonance space is formed, and it is thus possible to further increase the sound insulating advantage.

Furthermore, as the upper magnetic yoke 210 of the electromagnet unit 200 is applied as a closing plate that closes off the opened end surface of the contact housing case 102, there is no need to provide a separate closing plate, and it is thus possible to reduce the number of parts.

In this way, according to the embodiment, a C-shape is adopted for each of the contact conductor portions 115 of the pair of fixed contacts 111 and 112, the connecting plate portion 117 and upper plate portion 116 are disposed in proximity to the contact portion 118a so as to generate a Lorentz force opposing the electromagnetic repulsion force in the engaged state, and furthermore, the contact conductor portions 115 of the pair of fixed contacts 111 and 112 and the contact spring 134 are disposed in a parallel state in the extension direction of the movable contact 130. Because of this, it is possible to reduce the height of the contact device 100, and also possible to reduce the width, and thus possible to reduce the size of the whole contact device 100.

Moreover, it is possible to generate a Lorentz force opposing the electromagnetic repulsion force generated when engaging in the contact conductor portions 115 of the fixed contacts 111 and 112 between the contact portions 118a of the fixed contacts 111 and 112 and the contact portions 130a of the movable contact 130. Because of this, it is possible to reduce the biasing force of the contact spring 134, thus reducing the size thereof, and possible to reduce the height of the contact device 100 by this amount. Furthermore, the depressed portion 132 protruding on the side opposite to that of the fixed contact support insulating substrate 105 forming an upper plate, that is, the lower side, is formed in the position in which the movable contact 130 contacts the contact spring 134, thereby it is possible to further reduce the protruding height of the contact spring 134.

Incidentally, when omitting the contact conductor portion 115, forming a contact portion on the lower end of the support conductor portion 114, and disposing the movable contact 130 so as to be attachable to and detachable from the contact portion from below, the contact spring, movable contact, and fixed contacts are disposed in series in a vertical direction, and the height of the contact device 100 increases.

Further, the fixed contacts 111 and 112, movable contact 130, and movable plunger 215, which emit contact noise, are disposed in the hermetic chamber 240, the hermetic chamber 240 and the electromagnet unit 200 are covered by the internal case 101B, and a sound insulating resin material is injected into the interior of the internal case 101B, thus forming the sound insulating resin layer 150, thereby it is possible to reliably cut out contact noise emitted when switching to an engaged state or a released state. Furthermore, as the thicknesses of the sides of the external case 101A and the thicknesses of the sides of the internal case 101B are different, it is possible to have different rigidities and resonance frequencies of the external case 101A and internal case 101B, and thus possible to further suppress propagation to the exterior of contact noise, more ensuring quietness.

Moreover, as the encapsulated air layer 151 is further formed on the outer side of the sound insulating resin layer 150, it is also possible to obtain a sound insulating advantage from the encapsulated air layer 151, and thus possible to more reliably carry out sound insulation.

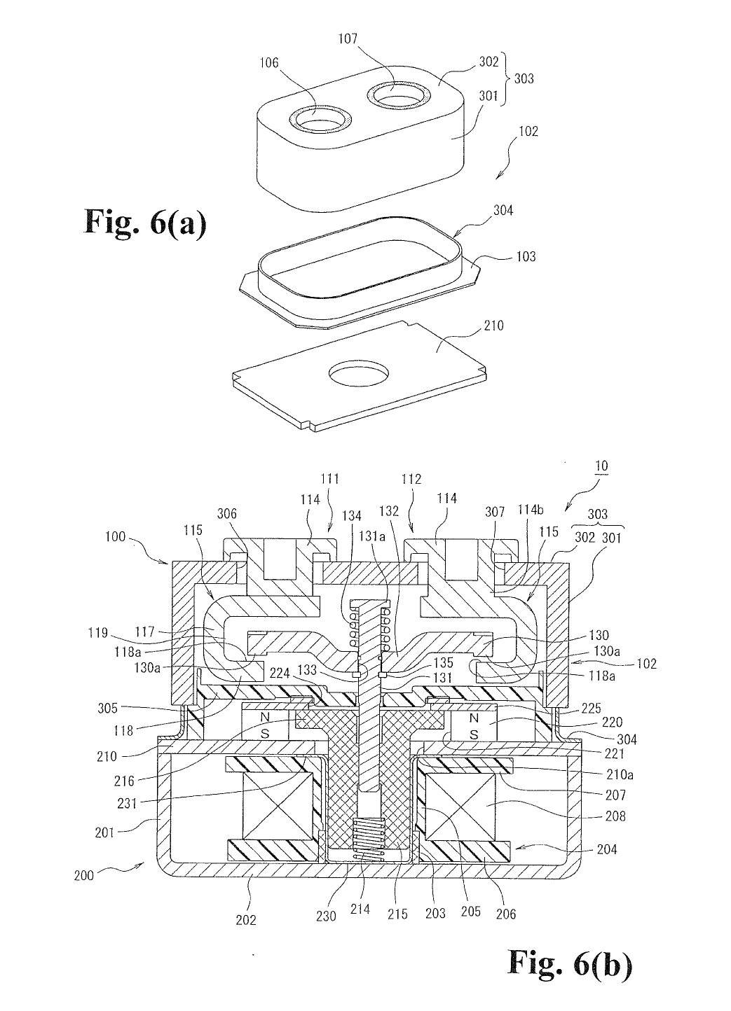

Next, a description will be given of a second embodiment of the invention, based on FIG. 6.

The second embodiment is a modification of the configuration of the contact housing case.

That is, in the second embodiment, as shown in FIGS. 6(a) and (b), a tubular portion 301 and an upper surface plate portion 302 closing off the upper end of the tubular portion 301 are formed integrally and made of a ceramic or a synthetic resin material, thereby forming a tub-form body 303, and a metal foil is formed on an opened end surface side of the tub-form body 303 by a metalizing process, and a metal connection member 304 is seal-joined to the metal foil, thus forming the contact housing case 102.

Further, a bottom plate portion 305 made of, for example, a synthetic resin, corresponding to the bottom plate portion 140b in the first embodiment, is disposed on the inner peripheral surface on the bottom surface side of the tub-form body 303.

Also, insertion holes 306 and 307 in which the fixed contacts 111 and 112 are inserted are formed in the upper surface plate portion 302, in the same way as the previously described contact support insulating substrate 105, and the fixed contacts 111 and 112 are supported by the insertion holes 306 and 307, in the same way as the first embodiment.

Further, although not shown, the contact housing case 102 and electromagnet unit 200 are covered by the internal case 101B and external case 101A, in the same way as the first embodiment, the sound insulating resin layer 150 is formed by injecting a sound insulating resin material into the interior of the internal case 101B, and the encapsulated air layer 151 is formed between the internal case 101B and external case 101A.

Configurations other than this have the same as the first embodiment, the same reference signs are given to portions corresponding to FIG. 2, and a detailed description thereof will be omitted.

According to the second embodiment, the contact housing case 102 includes the tub-form body 303 integrally molded of an insulating material, thereby it is possible to easily form the airtight contact housing case 102 in a small number of man-hours, and possible to reduce the number of parts.

In the first and second embodiments, a description has been given of a case wherein the opposing magnetic pole faces of the arc extinguishing permanent magnets 143 and 144 are N-poles, but the opposing magnetic pole faces are not limited to this, and it is also possible to obtain the same advantages as in the heretofore described embodiments if the opposing magnetic pole faces of the arc extinguishing permanent magnets 143 and 144 are S-poles, excepting that the direction of the magnetic flux crossing the arc and the direction of the Lorentz force are reversed.

Also, in the first and second embodiments, a description has been given of a case wherein the contact housing case 102 is formed by brazing the metal tubular body 104 and the fixed contact support insulating substrate 105 that closes off the upper end of the tubular body 104, but the contact housing case 102 is not limited to this. That is, the contact housing case 102 may be integrally formed in a tub-form with an insulating material, such as a ceramic or a synthetic resin material.

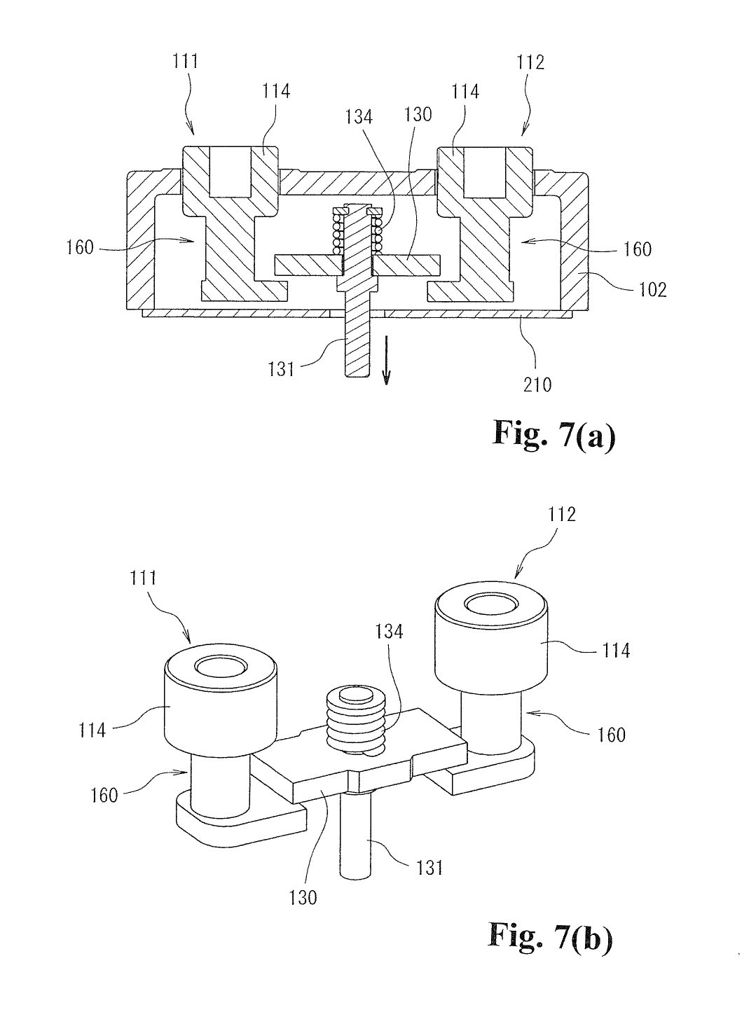

Also, in the first and second embodiments, a description has been given of a case wherein the contact conductor portion 115 is formed in the fixed contacts 111 and 112, but the contact conductor portion 115 is not limited to this, and an L-shaped portion 160, having a form omitting the upper plate portion 116 of the contact conductor portion 115, may be connected to the support conductor portion 114, as shown in FIGS. 7(a) and (b).

In this case, in a closed contact state wherein the movable contact 130 contacts the fixed contacts 111 and 112, it is possible to cause magnetic flux generated by the current flowing through a vertical plate portion of the L-shaped portion 160 to act on portions in which the fixed contacts 111 and 112 and the movable contact 130 are contacted. Because of this, it is possible to increase the magnetic flux density in the portions in which the fixed contacts 111 and 112 and the movable contact 130 are contacted, generating a Lorentz force that opposes the electromagnetic repulsion force.

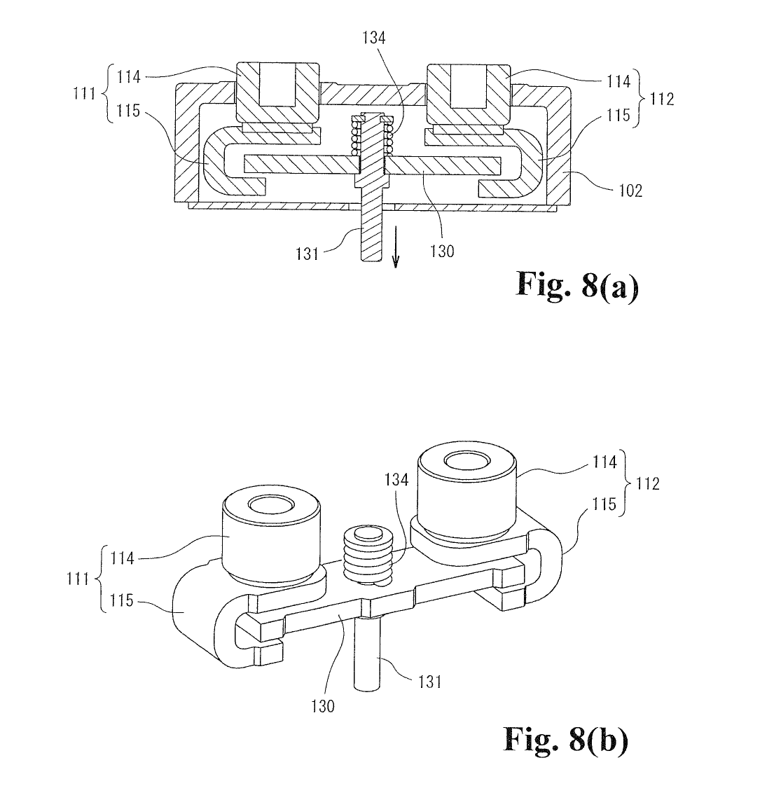

Also, in the heretofore described embodiments, a description has been given of a case wherein the movable contact 130 has the depressed portion 132 in a central portion thereof, but the movable contact 130 is not limited, and the depressed portion 132 may be omitted to form a flat plate, as shown in FIGS. 8(a) and (b).

Also, in the first and second embodiments, a description has been given of a case wherein the connecting shaft 131 is screwed to the movable plunger 215, but the movable plunger 215 and connecting shaft 131 may also be formed integrally.

Also, a description has been given of a case wherein the connection of the connecting shaft 131 and movable contact 130 is connected such that the flange portion 131a is formed on the leading end portion of the connecting shaft 131, and the lower end of the movable contact 130 is fixed with a C-ring after the connecting shaft 131 is inserted into the contact spring 134 and movable contact 130, but the connection is not limited. That is, a positioning large diameter portion may be formed and protrude in a radial direction in the C-ring position of the connecting shaft 131, the contact spring 134 disposed after the movable contact 130 contacts the large diameter portion, and the upper end of the contact spring 134 fixed with the C-ring.

Also, in the first and second embodiments, a description has been given of a case wherein the hermetic chamber 240 includes the contact housing case 102 and cap 230, and gas is encapsulated inside the hermetic chamber 240, but the hermetic chamber 240 is not limited, and the gas encapsulation may be omitted when the interrupted current is small.

Also, in the first and second embodiments, a description has been given of a case wherein the external receptacle 101C includes the external case 101A and internal case 101B, but the external receptacle 101C is not limited, and it is also possible to omit either one of the external case 101A and internal case 101B.

### INDUSTRIAL APPLICABILITY

According to the invention, it is possible to provide an electromagnetic contactor to cut out contact noise when a movable plunger is moved to an engaged position or a released state by covering a hermetic chamber and an electromagnet unit with a sound insulating resin layer.

### REFERENCE SIGNS LIST

10 . . . Electromagnetic contactor, 100 . . . Contact device, 101A . . . External case, 101B . . . Internal case, 101C . . . External receptacle, 102 . . . Contact housing case, 104 . . . Metal tubular body, 105 . . . Fixed contact support insulating substrate, 111, 112 . . . Fixed contact, 114 . . . Support conductor portion, 115 . . . Contact conductor portion, 116 . . . Upper plate portion, 117 . . . Connecting plate portion, 118 . . . Lower plate portion, 118a . . . Contact portion, 130 . . . Movable contact, 130a . . . Contact portion, 131 . . . Connecting shaft, 132 . . . Depressed portion, 134 . . . Contact spring, 140 . . . Insulating cylinder, 141, 142 . . . Magnet housing cylinder, 143, 144 . . . Arc extinguishing permanent magnet, 145, 146 . . . Arc extinguishing space, 150 . . . Sound insulating resin layer, 151 . . . Encapsulated air layer, 160 . . . L-shaped portion, 200 . . . Electromagnet unit, 201 . . . Magnetic yoke, 203 . . . Cylindrical auxiliary yoke, 204 . . . Spool, 208 . . . Exciting coil, 210 . . . Upper magnetic yoke, 214 . . . Return spring, 215 . . . Movable plunger, 216 . . . Peripheral flange portion, 220 . . . Permanent magnet, 225 . . . Auxiliary yoke, 301 . . . Tubular portion, 302 . . . Upper surface plate portion, 303 . . . Tub-form body, 304 . . . Connection member, 305 . . . Bottom plate portion

What is claimed is:

1. An electromagnetic contactor comprising:
a contact device having a pair of fixed contacts disposed to maintain a predetermined distance and a movable contact disposed so as to be attachable to and detachable from the pair of fixed contacts;
an electromagnet unit having a movable plunger that moves the movable contact of the contact device;
a hermetic chamber enclosing the pair of fixed contacts, the movable contact, and the movable plunger;
an external receptacle that covers the hermetic chamber and the electromagnet unit; and
a sound insulating resin layer injected and hardened between the hermetic chamber and the external receptacle.

2. The electromagnetic contactor according to claim 1, wherein the external receptacle includes an external case and an internal case disposed inside the external case, and an encapsulated air layer is formed between side surfaces of the external case and internal case facing each other.

3. The electromagnetic contactor according to claim 2, wherein thicknesses of the sides of the external case and thicknesses of the sides of the internal case are set to be different.

4. The electromagnetic contactor according to claim 1, wherein the hermetic chamber includes a tub-form contact housing case in which the pair of fixed contacts and the movable contact are disposed and which has an opening at an electromagnet unit side thereof, a closing plate that covers an open end of the contact housing case and through which at least a connecting shaft connecting the movable plunger and movable contact passes, and a cap disposed such that the movable plunger moves freely, and hermetically fixed to a side of the closing plate opposite to that of the contact housing case.

5. The electromagnetic contactor according to claim 4, wherein the closing plate includes an upper magnetic yoke forming the electromagnet unit.
